(19) United States
(12) Patent Application Publication
(10) Pub. No.: US 2020/0006852 A1
(43) Pub. Date: Jan. 2, 2020

(54) BOOSTER ANTENNA STRUCTURE, COMMUNICATION APPARATUS, AND CASE

(71) Applicant: SONY CORPORATION, TOKYO (JP)

(72) Inventor: KOICHI MATSUNO, KANAGAWA (JP)

(21) Appl. No.: 16/482,361

(22) PCT Filed: Feb. 5, 2018
(86) PCT No.: PCT/JP2018/003816

§ 371 Date: Jul. 31, 2019

(30) Foreign Application Priority Data
Feb. 23, 2017 (JP) 2017-031969

(51) Int. Cl. H01Q 7/06

(52) U.S. Cl. CPC H01Q 7/06; H01Q 1/2225

(57) ABSTRACT

[Object] To provide a technology in which it is possible to improve the communication performance of a communication apparatus.

[Solving Means] A booster antenna structure according to the present technology includes: a booster antenna magnetically coupled to an antenna coil of a coil substrate disposed inside a housing of a communication apparatus; and a first magnetic material sheet, the booster antenna structure being disposed at a position on an outer side relative to the coil substrate in the inside of the housing, and having a size larger than that of the coil substrate.

### TECHNICAL FIELD

The present technology relates to a technology such as a booster antenna used for short-range wireless communication.

### BACKGROUND ART

In the related art, various short-range wireless communication methods such as Near Field Communication (NFC) have been known as a contactless short-range communication method.

In short-range wireless communication, there is a case where an antenna called a booster antenna is used to extend a communication distance. The following Patent Literature 1 discloses a communication terminal apparatus that is provided with an antenna device having a booster antenna, a flexible coil substrate, and a magnetic material sheet. The booster antenna, the flexible coil substrate, and the magnetic material sheet have substantially the same size.

### CITATION LIST

### Patent Literature

Patent Literature 1: JP-A-2012-60372

### DISCLOSURE OF INVENTION

### Technical Problem

In a technique disclosed in Patent Literature 1, since the booster antenna and the flexible coil substrate have substantially the same size, there is a case where the size of the booster antenna is reduced, or there is a case where it is difficult to secure communication performance.

In view of circumstances described above, an object of the present technology is to provide a technology in which it is possible to improve the communication performance of a communication apparatus.

### Solution to Problem

A booster antenna structure according to the present technology includes: a booster antenna magnetically coupled to an antenna coil of a coil substrate disposed inside a housing of a communication apparatus; and a first magnetic material sheet, the booster antenna structure being disposed at a position on an outer side relative to the coil substrate in the inside of the housing, and having a size larger than a size of the coil substrate.

In this technique, since it is possible to make the size of the booster antenna structure larger than the size of the coil substrate, it is possible to improve the communication performance of the communication apparatus.

In the booster antenna structure, the booster antenna structure may be a laminated structure including the booster antenna and the first magnetic material sheet.

In the booster antenna structure, the first magnetic material sheet may be disposed between the booster antenna and the coil substrate.

In the booster antenna structure, a metal component may be disposed inside the housing, and the first magnetic material sheet may be disposed between the metal component and a portion where the booster antenna exceeds the coil substrate.

In this way, since it is possible to magnetically shield the booster antenna from the metal component, it is possible to appropriately improve the communication performance of the communication apparatus.

In the booster antenna structure, the first magnetic material sheet may have a notch at a position corresponding to the antenna coil.

In this way, it is possible to further appropriately improve the communication performance of the communication apparatus.

In the booster antenna structure, a size of the notch may be equal to or larger than a size of the antenna coil.

In this way, it is possible to further appropriately improve the communication performance of the communication apparatus.

In the booster antenna structure, the booster antenna and the first magnetic material sheet may be integrated to configure the booster antenna structure.

In the booster antenna structure, when the booster antenna structure is disposed inside the housing, the booster antenna structure may be individually disposed separately from the coil substrate.

In this way, it is possible to improve the incorporating property of the booster antenna structure into the housing.

In the booster antenna structure, the housing may have two or more inner surfaces, and the booster antenna structure may be provided across the two or more inner surfaces.

In this way, it is possible to perform communication from a plurality of directions to the communication apparatus.

In the booster antenna structure, the housing may have an inner surface, and the booster antenna structure may have a first portion disposed to overlap the coil substrate; and a second portion formed to be bent from the first portion and disposed along the inner surface of the housing.

In this way, even in a case where the coil substrate is disposed at a position distant from the inner surface of the housing, it is possible to secure the communication performance of the communication apparatus.

In the booster antenna structure, the booster antenna may have a first antenna part corresponding to the first portion; and a second antenna part corresponding to the second portion, and the first magnetic material sheet may have a magnetic material part disposed at a position on an inner side of the housing relative to the second antenna part.

In this way, it is possible to appropriately improve the communication performance of the communication apparatus by the magnetic material part.

In the booster antenna structure, the housing may have a metal part in a part of a place along the second portion, the booster antenna may have a first antenna part corresponding to the first portion; and a second antenna part corresponding to the second portion, and the first magnetic material sheet may have a magnetic material part disposed between the second antenna part and the metal part of the housing.

In this way, it is possible to magnetically shield the booster antenna from the metal part by the magnetic material part.

In the booster antenna structure, a metal component may be disposed inside the housing, and a second magnetic material sheet may be disposed between the coil substrate and the metal component.

In this way, it is possible to magnetically shield the coil substrate from the metal component.

In the booster antenna structure, another booster antenna structure including another booster antenna and another first magnetic material sheet may be provided in a case for accommodating the housing of the communication apparatus, and the booster antenna may be magnetically coupled to the other booster antenna in a state where the communication apparatus is accommodated in the case.

In this way, even in the state where the communication apparatus is accommodated in the case, it is possible to secure the communication performance of the communication apparatus.

In the booster antenna structure, the housing may have a metal part in a part, and the other first magnetic material sheet may be disposed between the other booster antenna and the metal part in the state where the communication apparatus is accommodated in the case.

In this way, it is possible to magnetically shield the other booster antenna from the metal part.

In another viewpoint of the present technology, a booster antenna structure includes: a booster antenna magnetically coupled to an antenna coil in a state where a communication apparatus having a housing in which the antenna coil is disposed is accommodated in a case for accommodating the housing; and a first magnetic material sheet, the booster antenna structure being disposed in the case.

In this way, even in the state where the communication apparatus is accommodated in the case, it is possible to secure the communication performance of the communication apparatus.

In the booster antenna structure, the housing may have a metal part in a part, and the first magnetic material sheet may be disposed between the booster antenna and the metal part in the state where the communication apparatus is accommodated in the case.

In this way, it is possible to magnetically shield the booster antenna from the metal part.

A communication apparatus according to the present technology includes a housing and a booster antenna structure. The booster antenna structure includes a booster antenna magnetically coupled to an antenna coil of a coil substrate disposed inside the housing, and a first magnetic material sheet, the booster antenna structure being disposed at a position on an outer side relative to the coil substrate in the inside of the housing, and having a size larger than a size of the coil substrate.

A case according to the present technology includes a case main body and a booster antenna structure. The case main body accommodates a housing of a communication apparatus, the communication apparatus having the housing in which an antenna coil is disposed. The booster antenna structure includes a booster antenna magnetically coupled to the antenna coil in a state where the communication apparatus is accommodated in the case main body, and a first magnetic material sheet, the booster antenna structure being disposed in the case main body.

### Advantageous Effects of Invention

As described above, according to the present technology, it is possible to provide a technology in which it is possible to improve the communication performance of a communication apparatus.

### BRIEF DESCRIPTION OF DRAWINGS

FIG. 1 is a schematic perspective view illustrating each member disposed inside a housing in a communication apparatus according to a first embodiment.

FIG. 2 is a schematic side sectional view of the communication apparatus and a schematic top view illustrating each member configuring the antenna device.

FIG. 3 is a view for describing each member configuring the antenna device, and a size of each part that each member has.

FIG. 4 is a view illustrating an assembling process of the communication apparatus.

FIG. 5 is a schematic side sectional view illustrating a situation when a communication apparatus and a reader/writer communicate with each other.

FIG. 6 is a view illustrating a current flowing to an antenna coil and a booster antenna.

FIG. 7 is a schematic perspective view illustrating each member disposed inside a housing in a communication apparatus according to a first comparative example.

FIG. 8 is a schematic side sectional view illustrating the communication apparatus according to the first comparative example.

FIG. 9 is a schematic side sectional view illustrating a communication apparatus according to a second comparative example.

FIG. 10 is a view illustrating various modified examples of a booster antenna structure.

FIG. 11 is a view illustrating various modified examples of the booster antenna structure.

FIG. 12 is a view illustrating various modified examples of the booster antenna structure.

FIG. 13 is a schematic side sectional view illustrating a communication apparatus according to a second embodiment.

FIG. 14 is a schematic side sectional view illustrating a communication apparatus according to a third embodiment.

FIG. 15 is a schematic side sectional view illustrating the communication apparatus according to a third comparative example.

FIG. 16 is a schematic sectional side view illustrating a situation when a communication apparatus according to the third embodiment and a reader/writer communicate with each other.

FIG. 17 is a schematic side sectional view illustrating a communication apparatus according to a fourth embodiment.

FIG. 18 is a schematic side sectional view illustrating a situation when a communication apparatus according to the fourth embodiment and a reader/writer communicate with each other.

FIG. 19 is a schematic side sectional view illustrating a communication apparatus and a case according to a fifth embodiment.

FIG. 20 is a schematic side sectional view illustrating a state where a communication apparatus is accommodated in a case according to a comparative example.

FIG. 21 is a schematic sectional view illustrating a situation when the communication apparatus and the reader/writer communicate with each other in a state where the communication apparatus is removed from the case.

FIG. 22 is a schematic side sectional view illustrating a situation when the communication apparatus and the reader/writer communicate with each other in a state where the communication apparatus is accommodated in the case according to the fifth embodiment.

FIG. 23 is a schematic side sectional view illustrating a communication apparatus and a case according to a sixth embodiment.

FIG. 24 is a schematic side sectional view illustrating a communication apparatus and a case according to a seventh embodiment.

### MODE(S) FOR CARRYING OUT THE INVENTION

Hereinafter, embodiments according to the present technology will be described with reference to the drawings.

### First Embodiment

### <Overall Configuration of Communication Apparatus 100 and Configuration of Each Part>

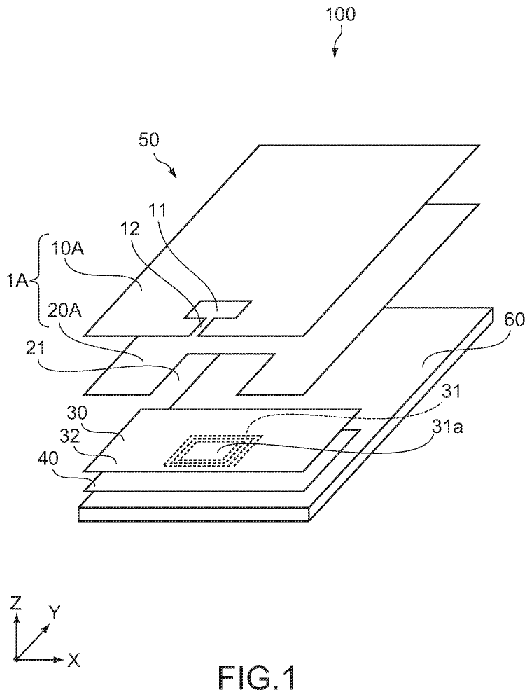

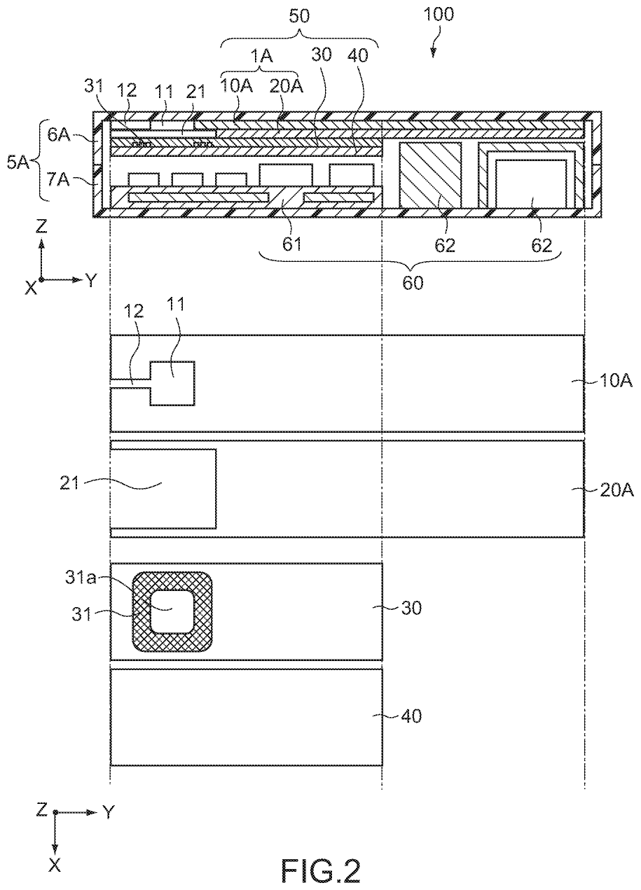

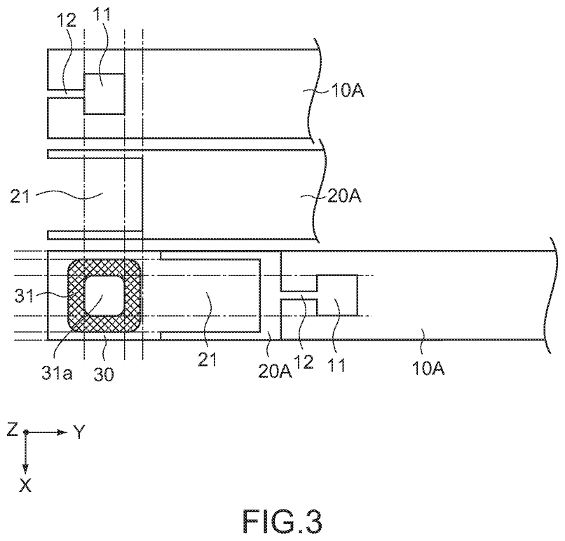

FIG. 1 is a schematic perspective view illustrating each member disposed inside a housing 5A in a communication apparatus 100. FIG. 2 is a schematic side sectional view of the communication apparatus 100 and a schematic top view illustrating each member configuring an antenna device 50. FIG. 3 is a view for describing each member configuring the antenna device 50 and a size of each part that each member has.

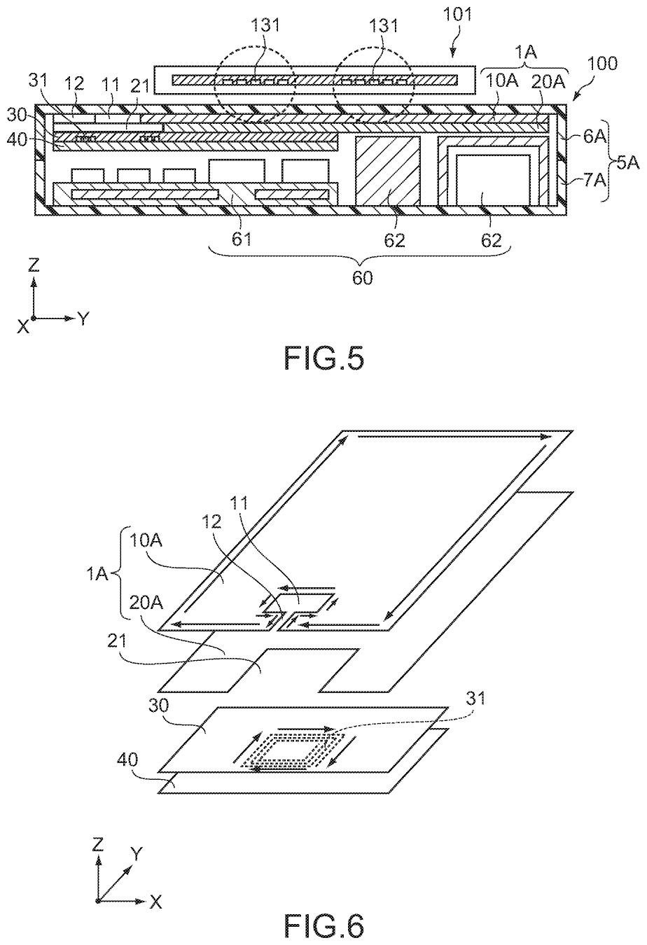

The communication apparatus 100 is various apparatus that performs communication with a reader/writer 101 (see FIG. 5) by a contactless short-range communication method such as NFC. The communication apparatus 100 is, for example, a mobile phone (including a smartphone), a portable game machine, a portable music player, a tablet PC (PC: personal computer), a wearable device (wristband type, neck type, head mounted type, and the like), a camera, a car navigation device, and the like.

Note that the communication apparatus 100 may be a contactless IC card (IC: Integrated Circuit) that is usable as electronic money in payment of a boarding fare for public transportation, payment for shopping at a store, and the like. Basically, the communication apparatus 100 may be any apparatus as long as it is able to communicate with the reader/writer 101 by the short-range communication method.

The reader/writer 101 (see FIG. 5) as a communication party of the communication apparatus 100 is, for example, various apparatus such as a tablet PC and a mobile phone (including a smartphone) with a reader/writer function mounted. Alternatively, the reader/writer 101 may be apparatus dedicated to the reader/writer. Basically, the reader/writer 101 may be any apparatus as long as it is able to communicate with the communication apparatus 100 by the short-range communication method.

Although a case where the communication apparatus 100 is the communication party of the reader/writer 101 will be described in this embodiment, the communication apparatus 100 itself may be the reader/writer 101.

As illustrated in FIGS. 1 to 3, the communication apparatus 100 has a housing 5A, an antenna device 50 disposed inside the housing 5A, and a metal component 60 disposed below the antenna device 50 in the inside of the housing 5A.

In the present embodiment, the housing 5A has a rectangular parallelepiped shape that is thin in a thickness direction (Z-axis direction), and an upper housing 6A and a lower housing 7A are configured to be bonded. In the description of the present embodiment, a width direction, a length direction, and the thickness direction of the housing 5A are respectively set as an X-axis direction, a Y-axis direction, and the Z-axis direction.

The housing 5A is typically configured with various materials such as resin and metal, but materials other than metal are used in at least a portion where the antenna device 50 is disposed (a portion in which communication is performed: an upper side in the example illustrated in the figure).

The metal component 60 includes a printed wiring board 61, and further includes various metallic components 62 such as a motor, a speaker, a microphone, an imaging device, and a cooling device which are not mounted on the printed wiring board 61. The printed wiring board 61 is configured by mounting various chip-like electronic components on a substrate provided with wiring.

The antenna device 50 includes a booster antenna structure 1A including a booster antenna 10A and a first magnetic material sheet 20A; a coil substrate 30; and a second magnetic material sheet 40. Here, the width (X-axis direction) of the booster antenna 10A, the first magnetic material sheet 20A, the coil substrate 30, and the second magnetic material sheet 40 illustrated in the lower side of FIG. 2 and FIG. 3 are represented by being reduced compared to that of FIG. 1 (exactly, a central area in the width direction is not reduced, and both sides in the width direction are reduced).

The coil substrate 30 has a support 32 and an antenna coil 31 supported by the support 32. The support 32 is a sheet-like member that is thin in the thickness direction (Z-axis direction), and in the present embodiment, the support 32 has a rectangular shape in plan view. Note that the shape of the support 32 may be circular, elliptical or the like, and the shape is not particularly limited.

The antenna coil 31 is configured to be wound in a spiral shape on the surface (the lower surface in the example illustrated in the figure) of the support 32 and has a coil opening 31a partitioned by the antenna coil 31 at the center position. In the present embodiment, the antenna coil 31 is rectangularly wound, and in this relationship, the coil opening 31a is also rectangular. Note that the shape of the antenna coil 31 or the coil opening 31a may be circular, elliptical, or the like, and the shape is not particularly limited.

The antenna coil 31 is electrically connected to the printed wiring board 61 through a pad electrode or the like provided on the support 32 of the coil substrate 30.

The booster antenna structure 1A has a laminated structure including a booster antenna 10A and a first magnetic material sheet 20A, and is disposed at a position on an outer side relative to the coil substrate 30 in the inside of the housing 5A. Also, the size of the booster antenna structure 1A (area or region in a plane. Herein, width X length:X-axis direction×Y-axis direction) is set larger than the size of the coil substrate 30.

The booster antenna 10A is able to be magnetically coupled to the antenna coil 31. The booster antenna 10A is a sheet-like member that is thin in the thickness direction (Z-axis direction) and configured with metal such as copper. In the present embodiment, the booster antenna 10A has a rectangular shape in plan view, but the shape of the booster antenna 10A may be circular, elliptical, or the like, and the shape is not particularly limited.

In the present embodiment, the thickness of the booster antenna 10A is thinner than a commonly used thickness, and is typically about 0.1 mm to 0.3 mm. Note that the thickness of the booster antenna 10A may be thinner than 0.1 mm, or may be thicker than 0.3 mm.

The size of the booster antenna 10A is set larger than the size of the coil substrate 30. In the present embodiment, the size of the booster antenna 10A in the width direction is substantially equal to the size of the coil substrate 30 in the width direction, but the size of the booster antenna 10A in the length direction is larger than the size of the coil substrate 30 in the length direction.

Also, the booster antenna 10A has the same size as the upper inner surface of the housing 5A, and the size is large enough to cover the entire upper inner surface of the housing 5A.

The booster antenna 10A has an opening 11 penetrating the booster antenna 10A in the thickness direction (Z-axis direction) at a position corresponding to the coil opening 31a. The size of the opening 11 in the booster antenna 10A is substantially equal to the size of the coil opening 31a, or smaller than the size of the coil opening 31a. In the present embodiment, the size of the opening 11 in the booster antenna 10A is substantially equal to the size of the coil opening 31a, and the shape of the opening 11 is rectangular according to the shape of the coil opening 31a.

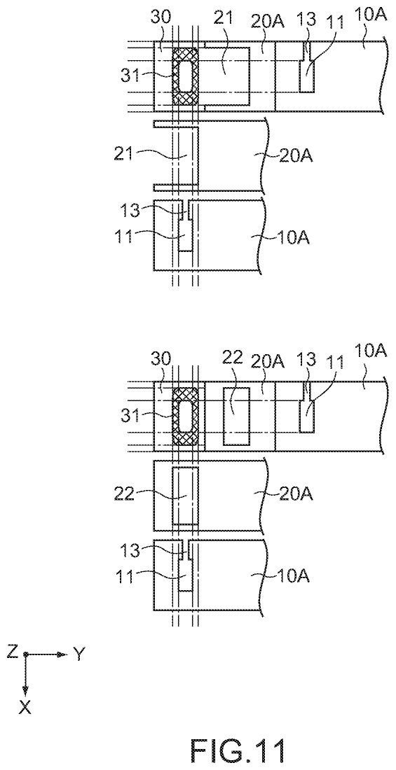

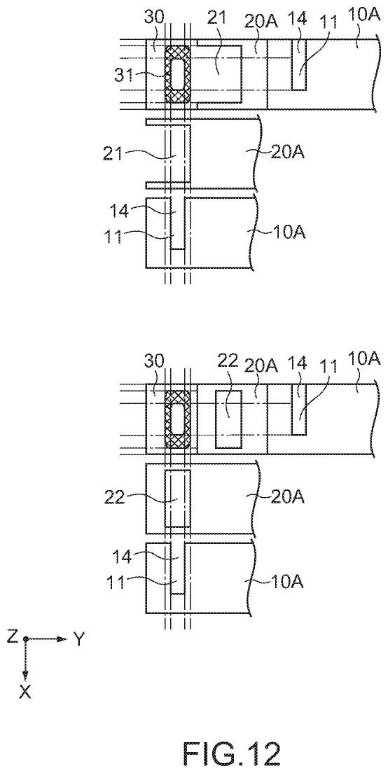

Also, the booster antenna 10A also has a slit part 12 connected between the opening 11 and an outer peripheral edge. In the present embodiment, the slit part 12 is formed along the length direction (Y-axis direction), and the width (X-axis direction) of the slit part 12 is smaller than the width (X-axis direction) of the opening 11. On the other hand, the slit part 12 may be formed along the width direction (X-axis direction), and the width of the slit part 12 may be a size substantially equal to the width of the opening 11 (see FIGS. 11 and 12 to be described later).

The first magnetic material sheet 20A is disposed between the booster antenna 10A and the coil substrate 30, and also disposed between the metal component 60 and a portion where the booster antenna 10A exceeds the coil substrate 30. The first magnetic material sheet 20A magnetically shields the metal component 60 from the portion where the booster antenna 10A exceeds the coil substrate 30 (a portion where the booster antenna 10A exceeds the second magnetic material sheet 20).

The first magnetic material sheet 20A is a sheet-like member that is thin in the thickness direction (Z-axis direction) and configured with, for example, a sintered magnetic material (for example, ferrite), a metal magnetic material or the like. Similarly to the booster antenna 10A, in the present embodiment, the first magnetic material sheet 20A has a rectangular shape in plan view, but the shape of the first magnetic material sheet 20A is circular, elliptical or the like, and the shape is not particularly limited.

In the present embodiment, the thickness of the first magnetic material sheet 20A is thinner than the commonly used thickness, and is typically about 0.1 mm to 0.3 mm. Note that the thickness of the booster antenna 10A may be thinner than 0.1 mm, or may be thicker than 0.3 mm.

The size of the first magnetic material sheet 20A is set to be the same size as the booster antenna 10A. In the present embodiment, the size of the first magnetic material sheet 20A in the width direction is substantially equal to the size of the coil substrate 30 in the width direction, but the size of the first magnetic material sheet 20A in the length direction is larger than the size of the coil substrate 30 in the length direction.

The first magnetic material sheet 20A has a notch 21 penetrating the first magnetic material sheet 20A in the thickness direction at a position overlapping with at least the antenna coil 31 and the coil opening 31a (a position corresponding to the antenna coil 31). The size of the notch 21 is substantially equal to the size of the outer periphery of the antenna coil 31, or larger than the size of the outer periphery of the antenna coil 31.

In the present embodiment, the notch 21 reaches the outer peripheral edge in a direction along the width direction (X-axis direction) of the first magnetic material sheet 20A. On the other hand, the notch 21 may not reach the outer peripheral edge of the first magnetic material sheet 20A.

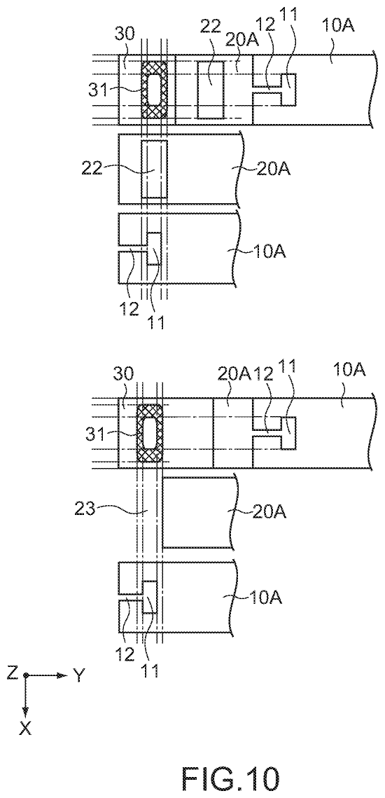

In this case, for example, a notch 21 having the same shape (rectangle) as the shape of the outer periphery of the antenna coil 31 and having the same size as the size of the outer periphery of the antenna coil 31 may be formed in the first magnetic material sheet 20A (see the upper side and the like of FIG. 10 to be described later). Alternatively, the left side of the first magnetic material sheet 20A may be entirely cut away from a position corresponding to the outer periphery on the right side of the antenna coil 31 to form the notch 21 (see the lower side of FIG. 10 to be described later).

The second magnetic material sheet 40 is disposed between the coil substrate 30 and the metal component 60. The second magnetic material sheet 40 magnetically shields the coil substrate 30 from the metal component 60. Similarly to the first magnetic material sheet 20A, the second magnetic material sheet 40 is a sheet-like member that is thin in the thickness direction (Z-axis direction) and configured with a sintered magnetic material (for example, ferrite), a metal magnetic material, and the like.

In the present embodiment, the second magnetic material sheet 40 has a rectangular shape in plan view, but the shape of the second magnetic material sheet 40 may be circular, elliptical, or the like, and the shape is not particularly limited.

The thickness of the second magnetic material sheet 40 is thinner than the commonly used thickness, and is typically about 0.1 mm to 0.3 mm. Note that the thickness of the second magnetic material sheet 40 may be thinner than 0.1 mm, or may be thicker than 0.3 mm. The size of the second magnetic material sheet 40 is set to be the same size as the coil substrate 30.

The booster antenna 10A and the first magnetic material sheet 20A are fixed to each other through an adhesive layer or the like, and are integrated to form a booster antenna structure 1A. The booster antenna structure 1A is fixed to the upper inner surface of the housing 5A through an adhesive layer or the like. Also, the coil substrate 30 and the second magnetic material sheet 40 are fixed to each other through an adhesive layer or the like.

Here, the coil substrate 30 and the booster antenna structure 1A may be fixed to each other through an adhesive layer or the like, but in the present embodiment, the coil substrate 30 and the booster antenna structure 1A are not fixed to each other (at least when the communication apparatus 100 is assembled). That is, in the present embodiment, the booster antenna structure 1A is individualized from the coil substrate 30 and the second magnetic material sheet 40.

### <Assembling Process of Communication Apparatus 100>

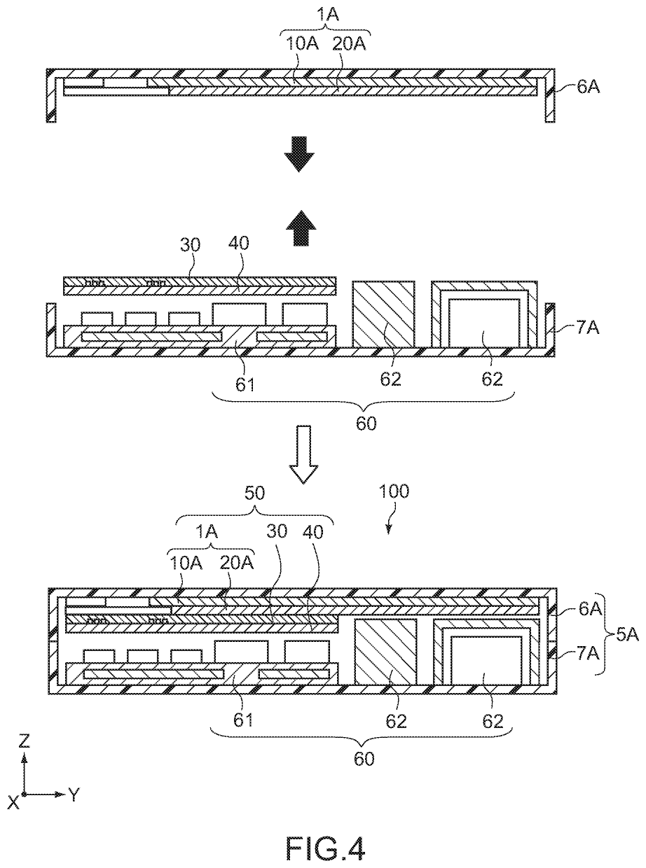

Next, an assembling process of the communication apparatus 100 will be described. FIG. 4 is a view illustrating an assembling process of the communication apparatus 100.

As illustrated in FIG. 4, first, on an upper housing 6A side, the booster antenna structure 1A configured by integrating the booster antenna 10A and the first magnetic material sheet 20A is fixed to the upper inner surface of the upper housing 6A. That is, when the booster antenna structure 1A is disposed inside the housing 5A, the booster antenna structure 1A is individually disposed separately from the coil substrate 30 and the second magnetic material sheet 40.

On the other hand, on a lower housing 7A side, first, the metal component 60 is fixed to the lower inner surface of the lower housing 7A. Then, the coil substrate 30 and the second magnetic material sheet 40 are fixed to the upper side of the metal component 60 (the upper side of the printed wiring board 61, in the example illustrated in the figure) through a spacer or the like. Thereafter, the upper housing 6A and the lower housing 7A are bonded, and assembling in the communication apparatus 100 is completed.

### <Operations in Communication>

Next, operations when the communication apparatus 100 and the reader/writer 101 communicate with each other will be described. FIG. 5 is a schematic side sectional view illustrating a situation when the communication apparatus 100 and the reader/writer 101 communicate with each other. FIG. 6 is a view illustrating a current flowing to the antenna coil 31 and the booster antenna 10A.

First, an operation when the communication apparatus 100 receives information from the reader/writer 101 will be described. Note that communication between the communication apparatus 100 and the reader/writer 101 is basically started from the reader/writer 101.

Once a current flows in an antenna coil 131 of the reader/writer 101, a magnetic field is generated in the antenna coil 131, and the magnetic field interlinks with the booster antenna 10A of the communication apparatus 100. In this way, the antenna coil 131 of the reader/writer 101 and the booster antenna 10A of the communication apparatus 100 are magnetically coupled, and a current flows along the outer peripheral edge of the booster antenna 10A.

The current flowing along the outer peripheral edge of the booster antenna 10A flows around the opening 11 by passing around the slit part 12. Once a current flows around the opening 11, a magnetic field is generated in the opening 11, and the magnetic field interlinks with the antenna coil 31 of the communication apparatus 100. In this way, in the communication apparatus 100, the booster antenna 10A and the antenna coil 31 are magnetically coupled, and a current flows in the antenna coil 31 in a direction opposite to the direction of the current flowing around the opening 11. In this way, the communication apparatus 100 receives information from the reader/writer 101.

Next, an operation when the communication apparatus 100 transmits information to the reader/writer 101 will be described.

Once a current flows in the antenna coil 31 of the communication apparatus 100, a magnetic field is generated in the antenna coil 31, and the magnetic field interlinks with the booster antenna 10A. In this way, in the communication apparatus 100, the antenna coil 31 and the booster antenna 10A are magnetically coupled, and a current flows around the opening 11 of the booster antenna 10A in a direction opposite to the direction of the current flowing in the antenna coil 31.

The current flowing around the opening 11 of the booster antenna 10A passes around the slit part 12 and flows along the outer peripheral edge. Once a current flows through the booster antenna 10A, a magnetic field is generated by the booster antenna 10A, and the magnetic field performs coupling with the antenna coil 131 of the reader/writer 101. In this way, information from the communication apparatus 100 is transmitted to the reader/writer 101.

### <Action and the Like>

Next, an action and the like in the present embodiment will be described. In the description of the action and the like, first, a comparative example to be compared with the present embodiment will be described.

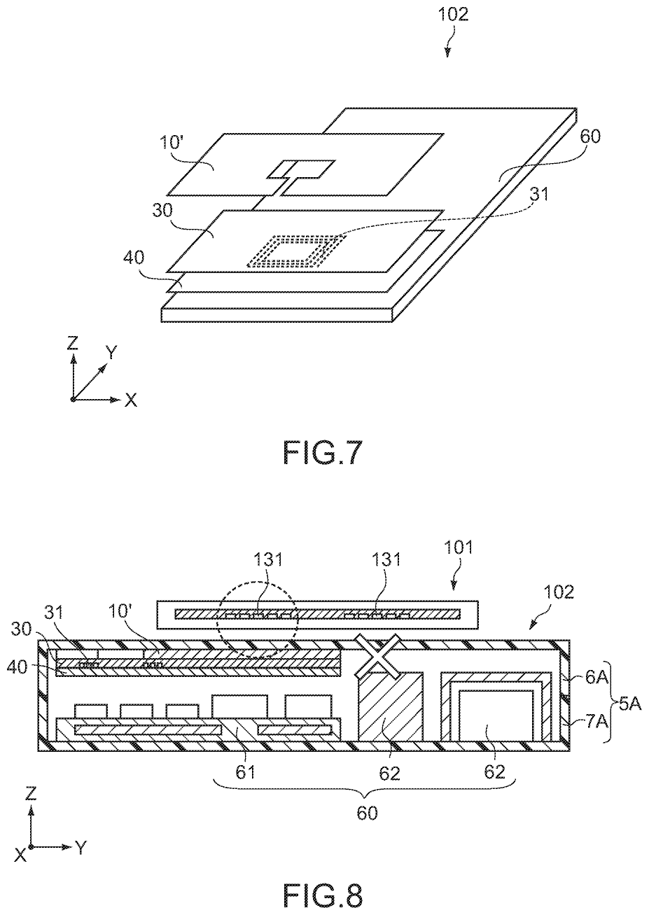

FIG. 7 is a schematic perspective view illustrating each member disposed inside the housing 5A in a communication apparatus 102 according to the first comparative example. FIG. 8 is a schematic side sectional view illustrating the communication apparatus 102 according to the first comparative example.

As illustrated in FIGS. 7 and 8, the communication apparatus 102 according to the first comparative example does not have the first magnetic material sheet 20A, and the sizes of a booster antenna 10′, the coil substrate 30, and the second magnetic material sheet 40 are the same.

In the communication apparatus 102 according to the first comparative example, the size of the booster antenna 10′ is small. Therefore, as illustrated in FIG. 8, once a position of the antenna coil 131 in the reader/writer 101 is slightly deviated from a position of the booster antenna 10′, it is not possible to sufficiently secure communication performance. In the example illustrated in FIG. 8, out of the antenna coil 131 in the reader/writer 101, a portion represented on the left side is magnetically coupled to the booster antenna 10′, but a portion represented on the right side is not magnetically coupled to the booster antenna 10′. As described above, in the communication apparatus 102 according to the first comparative example, it is not possible to sufficiently secure communication performance between communication apparatus 102 and the reader/writer 101.

Therefore, in the present embodiment, the size of the booster antenna 10A is set to be larger than the size of the coil substrate 30. In this way, in the present embodiment, as illustrated in FIG. 5, out of the antenna coil 131 in the reader/writer 101, both portions represented on the left and the right sides are able to be magnetically coupled to the booster antenna 10A. As described above, in the present embodiment, it is possible to improve the communication performance of the communication apparatus 100.

On the other hand, in the communication apparatus 102 according to the first comparative example, it is not possible to appropriately secure communication performance simply by making the size of the booster antenna 10′ larger than the size of the coil substrate 30.

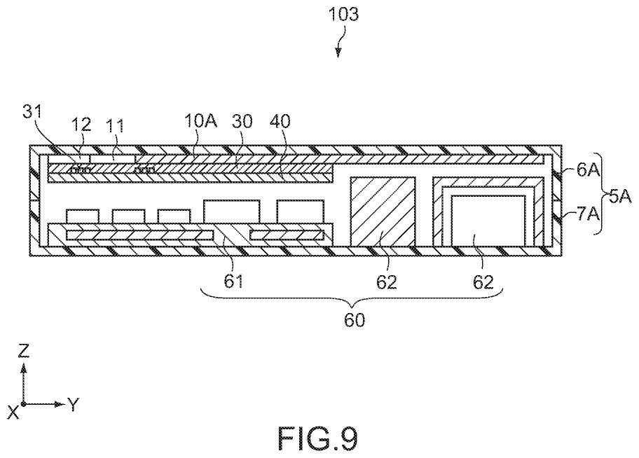

Here, as a communication apparatus 103 according to a second comparative example, there is considered a case where the size of the booster antenna 10′ in the communication apparatus 102 according to the first comparative example is larger than the size of coil substrate 30. FIG. 9 is a schematic side sectional view illustrating the communication apparatus 103 according to the second comparative example. As compared with the communication apparatus 100 according to the present embodiment, the first magnetic material sheet 20A is skipped in the communication apparatus 103 according to the second comparative example.

In the communication apparatus 103 according to the second comparative example, the second magnetic material sheet 40 is interposed between the booster antenna 10A and the metal component 60. On the other hand, no magnetic material sheet is interposed between the booster antenna 10A and the metal component 60 in a portion where the booster antenna 10A exceeds the coil substrate 30.

In this case, there is considered a case where the communication apparatus 103 receives information from the reader/writer 101 by means of the magnetic field generated by the antenna coil 131 in the reader/writer 101. Here, once attention is paid to a portion where the booster antenna 10A exceeds the coil substrate 30 (a portion on the lower side where there is no magnetic material sheet), a magnetic field generated by the antenna coil 131 of the reader/writer 101 is coupled to the metal component 60 positioned below this portion to be damped. This effect degrades communication performance.

Also, there is considered a case where the communication apparatus 103 transmits information to the reader/writer 101 by means of the magnetic field generated by the antenna coil 31 in the communication apparatus 103. Once attention is paid to a portion where the booster antenna 10A exceeds the coil substrate 30, a magnetic field generated by the antenna coil 31 of the communication apparatus 103, or a magnetic field of the booster antenna 10A generated by this magnetic field is coupled to a metal component 60 positioned below this portion to be damped. This effect degrades communication performance.

On the other hand, in the communication apparatus 100 according to the present embodiment, the first magnetic material sheet 20A is interposed between the booster antenna 10A and the coil substrate 30. Also, the size of the first magnetic material sheet 20A is a size substantially equal to that of the booster antenna 10A (larger than the size of the coil substrate 30). That is, in the first magnetic material sheet 20A, a part of the first magnetic material sheet 20A is interposed between the metal component 60 and a portion where the booster antenna 10A exceeds the coil substrate 30. Therefore, in the communication apparatus 100 according to the present embodiment, it may be prevented that each magnetic field generated, when communication with the reader/writer 101 is performed, is damped due to an adverse effect of the metal component 60 positioned below the portion.

Also, in the communication apparatus 100 according to the present embodiment, the notch 21 is formed in the first magnetic material sheet 20A at a position corresponding to the antenna coil 31. The size of the notch 21 is substantially equal to the size of the outer periphery of the antenna coil 31 of the communication apparatus 100, or larger than the size of the outer periphery of the antenna coil 31 of the communication apparatus 100. In this way, when the booster antenna 10A is magnetically coupled to the antenna coil 31 of the communication apparatus 100, it is possible to prevent the first magnetic material sheet 20A from disturbing magnetic coupling, and it is possible to appropriately secure the communication performance of the communication apparatus 100.

Furthermore, in the communication apparatus 100 according to the present embodiment, the booster antenna structure 1A is individualized from the coil substrate 30 and the second magnetic material sheet 40, and when the booster antenna structure 1A is disposed inside the housing 5A, the booster antenna structure 1A is individually disposed separately from the coil substrate 30 and the second magnetic material sheet 40. In this way, it is possible to improve the incorporating property of the booster antenna structure 1A into the housing 5A, and it is possible to make a thickness of the communication apparatus 100 thinner.

### <Various Modified Examples of Booster Antenna Structure 1A>

Next, various modified examples of the booster antenna structure 1A will be described. FIGS. 10 to 12 are views illustrating various modified examples of the booster antenna structure 1A. Note that various modified examples described here are similarly applicable to respective embodiments to be described later.

With reference to the figure on the upper side of FIG. 10, in the example illustrated in this figure, a shape of a notch 22 of the first magnetic material sheet 20A is different from a shape of the notch 21 illustrated in FIGS. 1 to 3 and the like. In the example illustrated to this figure, the notch 22 of the first magnetic material sheet 20A is formed as a rectangular opening. This notch 22 has the same size and shape (rectangle) as the shape of the outer periphery of the antenna coil 31.

With reference to the figure on the lower side of FIG. 10, in the example illustrated in this figure, a shape of a notch 23 of the first magnetic material sheet 20A is different from a shape of the notch 21 illustrated in FIGS. 1 to 3 and the like. In the example illustrated in this figure, the left side of the first magnetic material sheet 20A is entirely cut away from a position corresponding to the outer periphery on the right side of the antenna coil 31 to form the notch 23.

With reference to the figure on the upper side of FIG. 11, in the example illustrated in this figure, a slit part 13 of the booster antenna 10A is different from the slit part 12 illustrated in FIGS. 1 to 3. In the example illustrated to this figure, the slit part 13 of the booster antenna 10A is formed along the width direction (X-axis direction), instead of the length direction (Y-axis direction).

With reference to the figure on the lower side of FIG. 11, in the example illustrated in this figure, the slit part 13 of the booster antenna 10A and the notch 22 of the first magnetic material sheet 20A are different from those in the example illustrated in FIGS. 1 to 3. In the example illustrated to this figure, the slit part 13 of the booster antenna 10A is formed along the width direction (X-axis direction). Also, the notch 22 of the first magnetic material sheet 20A is formed as a rectangular opening.

With reference to the figure on the upper side of FIG. 12, in the example illustrated in this figure, a slit part 14 of the booster antenna 10A is different from the slit part 12 illustrated in FIGS. 1 to 3. In the example illustrated in this figure, the slit part 14 of the booster antenna 10A is formed along the width direction (X-axis direction). Also, the width (the Y-axis direction, for the sake of convenience, in the description herein) of the slit part 14 is a size substantially equal to the width (the Y-axis direction, for the sake of convenience, in the description herein) of the opening 11 of the booster antenna 10A.

With reference to the figure on the lower side of FIG. 12, in the example illustrated in this figure, the slit part 14 of the booster antenna 10A and the notch 22 of the first magnetic material sheet 20A are different from those in the example illustrated in FIGS. 1 to 3. In the example illustrated in this figure, the slit part 12 of the booster antenna 10A is formed along the width direction (X-axis direction). Also, the width (the Y-axis direction, for the sake of convenience, in the description herein) of the slit part 12 is a size substantially equal to the width (the Y-axis direction, for the sake of convenience, in the description herein) of the opening 11 of the booster antenna 10A. Also, in the example illustrated to this figure, the notch 22 of the first magnetic material sheet 20A is formed as a rectangular opening.

### Second Embodiment

Next, a second embodiment of the present technology will be described. In the subsequent description of the second embodiment, members having the same configurations and functions as those of the first embodiment described above are denoted by the same reference numerals, and descriptions thereof will not be repeated or will be simplified. Also, in the subsequent description of the second embodiment, differences from the aforementioned first embodiment will be mainly described.

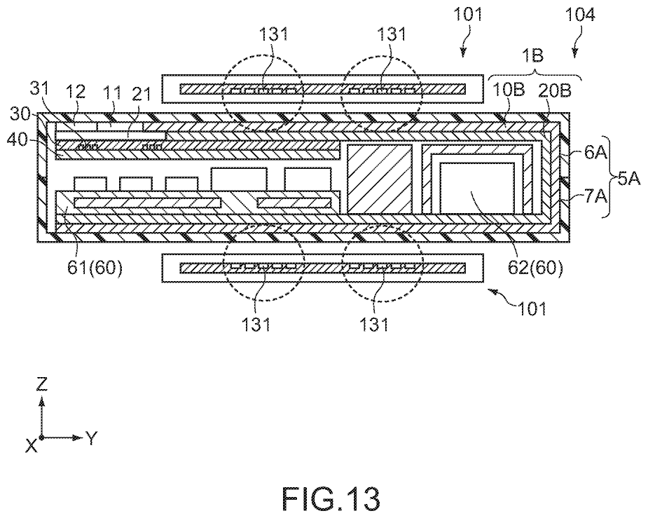

FIG. 13 is a schematic side sectional view illustrating a communication apparatus 104 according to the second embodiment. In the communication apparatus 104 according to the second embodiment, configurations of a booster antenna structure 1B are different from those of the booster antenna structure 1A according to the aforementioned first embodiment.

Similarly to the first embodiment, the booster antenna structure 1B according to the second embodiment has a laminated structure including the booster antenna 10B and the first magnetic material sheet 20B, and is disposed on an outer side relative to the coil substrate 30.

Also, similarly to the first embodiment, a size of the booster antenna structure 1B according to the second embodiment is larger than the size of the coil substrate 30, but the length thereof is formed to be longer than that of the first embodiment.

As illustrated in FIG. 13, this booster antenna structure 1A is provided across three inner surfaces along three inner surfaces of the upper inner surface, the right inner surface, and the lower inner surface of the housing 5A.

In this way, when communication is performed by bringing the reader/writer 101 close to the communication apparatus 104, it is possible to perform communication by bringing the reader/writer 101 close to the communication apparatus 104 from a plurality of directions. Also, in a case where communication is performed by bringing the communication apparatus 104 close to the reader/writer 101, it is possible to perform communication regardless of the posture of the communication apparatus 104. Note that, in the example illustrated in FIG. 13, a situation when communication is performed by bringing the reader/writer 101 close to the upper side and the lower side of the communication apparatus 104 is illustrated.

In the example illustrated in FIG. 13, a case where the booster antenna structure 1A is provided across three inner surfaces out of the six inner surfaces of the housing 5A has been described. On the other hand, the antenna structure may be provided across two inner surfaces, or four or more inner surfaces out of the inner surfaces of the housing 5A (that is, the booster antenna structure 1A may be provided across two or more inner surfaces)).

### Third Embodiment

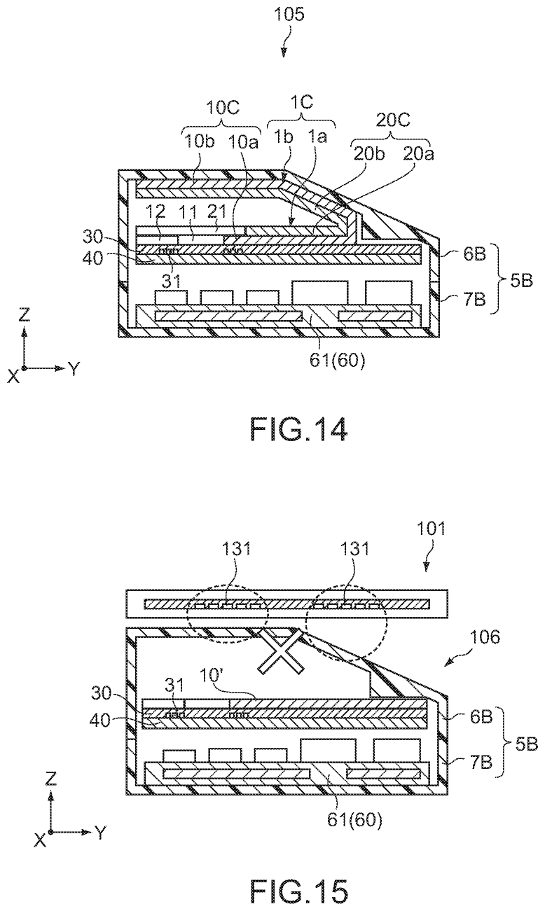

Next, a third embodiment of the present technology will be described. FIG. 14 is a schematic side sectional view illustrating a communication apparatus 105 according to the third embodiment.

As compared with the aforementioned respective embodiments, in the communication apparatus 105 according to the third embodiment, configurations of a housing 5B and a booster antenna structure 1C are different.

As illustrated in FIG. 14, the communication apparatus 105 has a housing 5B including an upper housing 6B and a lower housing 7B. The housing 5B has a shape thicker in the thickness direction than the housing 5A according to the aforementioned respective embodiments. Also, the housing 5B does not have a simple rectangular parallelepiped shape, but has a shape (a heptahedron) in which one upper corner of the rectangular parallelepiped shape is notched obliquely along the width direction (X-axis).

Note that, in the third embodiment, on the upper side of the housing 5B, a portion parallel to a horizontal plane (XY plane) is called an upper portion of the housing 5B, and on the upper side of the housing 5B, an obliquely inclined portion (an upper right portion in FIG. 14) is called a tapered portion (similarly applicable to the fourth embodiment to be described later).

Note that, in the third embodiment, the coil substrate 30 requiring flatness and the second magnetic material sheet 40 disposed below the coil substrate 30 are disposed at a position (a recessed position) distant from the upper inner surface of the housing 5B, in connection with the housing 5B having a complicated shape.

Similarly to the aforementioned respective embodiments, the booster antenna structure 1C according to the third embodiment has a laminated structure including the booster antenna 10C and the first magnetic material sheet 20C, and is disposed on an outer side relative to the coil substrate 30. Also, similarly to the aforementioned respective embodiments, the size of the booster antenna structure 1C according to the third embodiment is larger than the size of the coil substrate 30.

On the other hand, differently to the aforementioned respective embodiments, the booster antenna structure 1C according to the third embodiment is formed to be folded back along a fold in a direction along the width direction (X-axis direction) in a central area of the length direction (Y-axis direction).

Specifically, the booster antenna structure 1C has a first portion 1a (the first portion 1a is not disposed along the inner surface of the housing 5B) disposed to overlap the coil substrate 30. Also, the booster antenna structure 1C has a second portion 1b formed to be folded back (bent) from the first portion 1a and disposed along the inner surface of the housing 5B (the second portion 1b is not disposed to overlap the coil substrate 30). The second portion 1b is disposed along the inner surface of the upper portion and the tapered portion of the housing 5B.

The booster antenna 10C has a first antenna part 10a corresponding to the first portion 1a and a second antenna part 10b corresponding to the second portion 1b. That is, the booster antenna 10C has the first antenna part 10a disposed to overlap the coil substrate 30, and the second antenna part 10b formed to be folded back (bent) from the first antenna part 10a and disposed along the inner surface of the housing 5B.

Similarly, the first magnetic material sheet 20C has a first magnetic material part 20a corresponding to the first portion 1a and a second magnetic material part 20b corresponding to the second portion 1b. That is, the first magnetic material sheet 20C has the first magnetic material part 20a disposed to overlap the coil substrate 30, and the second magnetic material part 20b formed to be folded back (bent) from the first magnetic material part 20a and disposed along the inner surface of the housing 5B.

Here, in the booster antenna structure 10, attention is paid to the first portion 1a disposed to overlap the coil substrate 30. In the first portion 1a, the first antenna part 10a of the booster antenna 100 is disposed on the coil substrate 30, and the first magnetic material part 20a of the first magnetic material sheet 20C is disposed on the first antenna part 10a.

That is, the first antenna part 10a is disposed on the inner side of the housing 5B relative to the first magnetic material part 20a, and vice versa, the first magnetic material part 20a is disposed on the outer side of housing 5B relative to the first antenna part 10a. Note that the first antenna part 10a is interposed between the first magnetic material part 20a and the coil substrate 30.

Next, in the booster antenna structure 10, attention is paid to the second portion 1b formed to be folded back from the first portion 1a. In the second portion 1b, the second antenna part 10b of the booster antenna 100 is disposed on the second magnetic material part 20b of the first magnetic material sheet 20C. That is, the second antenna part 10b is disposed on the outer side of the housing 5B relative to the second magnetic material part 20b, and vice versa, the second magnetic material part 20b is disposed on the inner side of the housing 5B relative to the second antenna part 10b.

Note that, in the booster antenna structure 1C, relationship between vertical positions of the booster antenna 10C and the first magnetic material sheet 20C is reversed in the first portion 1a and the second portion 1b, in connection with the second portion 1b being formed to be folded back from the first portion 1a.

Here, in the aforementioned respective embodiments, the first magnetic material sheets 20A and 20B are disposed on the coil substrate 30, and the booster antennas 10A and 10B are disposed on the first magnetic material sheets 20A and 20B. Therefore, as compared with the aforementioned respective embodiments, in the first portion 1a, vertical relationship between the booster antenna 10C and the first magnetic material sheet 20C is reversed. On the other hand, as compared with the aforementioned respective embodiments, in the second portion 1b not to be disposed to overlap the coil substrate 10, vertical relationship between the booster antenna 10C and the first magnetic material sheet 20C is the same.

Next, a communication apparatus 106 according to a third comparative example will be described. FIG. 15 is a schematic side sectional view of the communication apparatus 106 according to the third comparative example. Differently to the third embodiment, as illustrated in FIG. 15, the communication apparatus 106 according to the third comparative example does not have the first magnetic material sheet, and the sizes of the booster antenna 10′, the coil substrate 30, and the second magnetic material sheet 40 are the same. Also, the booster antenna 10′, the coil substrate 30, and the second magnetic material sheet 40 are disposed in an order from the top, and the booster antenna 10′ is not formed to be folded back.

For example, in a case where the coil substrate 30 requiring flatness is disposed inside the housing 5B having a complicated structure, as illustrated in FIG. 15, the coil substrate 30 may have to be disposed at a position distant from the inner surface of the housing 5B, in connection with the restriction of disposition inside the housing 5B. In such a case, it is not possible to secure communication performance between the communication apparatus 106 and the reader/writer 101 simply by disposing the booster antenna 10′ on the coil substrate 30.

Note that, FIG. 15 illustrates a situation when the magnetic field of the antenna coil 131 of the reader/writer 101 does not reach the booster antenna 10′ in the communication apparatus 106, and the communication apparatus 106 and the reader/writer 101 are not able to appropriately communicate with each other.

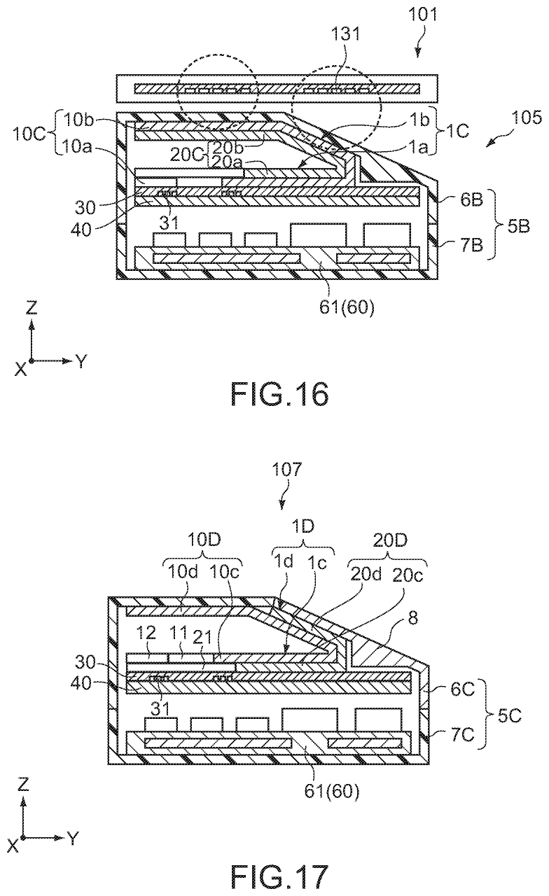

FIG. 16 is a schematic side sectional view illustrating a situation when the communication apparatus 105 according to the third embodiment and the reader/writer 101 communicate with each other. As illustrated also in FIG. 16, in the booster antenna structure 1C of the third embodiment, the second portion 1b formed to be folded back from the first portion 1a is disposed along the inner surface of the housing 5B. Therefore, in connection with the restriction of disposition inside the housing 5B, even though the coil substrate 30 is disposed at a position distant from the inner surface of the housing 5B, it is possible to appropriately secure communication performance between the communication apparatus 105 and the reader/writer 101.

Note that, FIG. 16 illustrates a situation when the magnetic field of the antenna coil 31 of the reader/writer 101 interlinks with the booster antenna 10C in the communication apparatus 105, and the communication apparatus 105 and the reader/writer 101 appropriately communicate with each other.

Similarly to the first embodiment, also in the third embodiment, when the booster antenna structure 1C is disposed inside the housing 5B, the booster antenna structure 1C may be individually disposed separately from the coil substrate 30 and the second magnetic material sheet 40 (see FIG. 4: similarly applicable to the fourth embodiment). In this way, it is possible to improve the incorporating property of the booster antenna structure 1C into the housing 5B. In particular, in the third embodiment, since the housing 5B has a complicated structure, it is particularly effective to improve the incorporating property of the booster antenna structure 1C into the housing 5B.

Here, in the second portion 1b of the booster antenna structure 1C, the second magnetic material part 20b of the first magnetic material sheet 20C is disposed below the second antenna part 10b of the booster antenna 10C.

By disposing the second magnetic material part 20b at such a position, when the communication apparatus 105 receives information from the reader/writer 101, the magnetic field generated by the antenna coil 131 of the reader/writer 101 is able to be magnetically coupled to the booster antenna 10C, appropriately. Also, when information is transmitted from the communication apparatus 105 to the reader/writer 101, it is possible to expand a radiation range of the magnetic field generated by the antenna coil 31. Note that the first magnetic material part 20a of the first magnetic material sheet 20C may be skipped as necessary.

### Fourth Embodiment

Next, a fourth embodiment of the present technology will be described. FIG. 17 is a view illustrating the communication apparatus 107 according to a fourth embodiment.

In the description of the fourth embodiment, differences from the aforementioned third embodiment will be mainly described. Once differences from the third embodiment will be briefly described, the fourth embodiment is different from the third embodiment in that a part of the housing 5C is configured with metal, and in that vertical relationship between the booster antenna 10D and the first magnetic material sheet 20D is reversed. Hereinafter, specific description will be provided.

As illustrated in FIG. 17, the housing 5C including the upper housing 6C and the lower housing 6C has the same shape as the housing 5B according to the third embodiment. On the other hand, differently to the housing 5B according to the third embodiment, the housing 5C has a metal part 8 in a part (upper right in the figure: a part of a place along a second portion 1d of the booster antenna structure 1D) of the upper housing 6C of the housing 5C. That is, in the fourth embodiment, the tapered portion is configured with metal (other portions are configured with nonmetal such as resin).

Similarly to the third embodiment, the booster antenna structure 1D according to the fourth embodiment is formed to be folded back along a fold in a direction along the width direction (X-axis direction) in a central area of the length direction (Y-axis direction).

Also, similarly to the third embodiment, the booster antenna structure 1D according to the fourth embodiment has a first portion 1c (this first portion 1c is not disposed along the inner surface of a housing 5C) disposed to overlap the coil substrate 30. Also, similarly to the third embodiment, the booster antenna structure 1D according to the fourth embodiment is the second portion 1d (this second portion 1d is not disposed to overlap with the coil substrate 30) formed to be folded back (bent) from the first portion 1c, and disposed along the inner surface of the housing 5C. The second portion 1d is disposed along the inner surfaces of the upper portion and the tapered portion of the housing 5C.

Also, similarly to the third embodiment, the booster antenna 10D according to the fourth embodiment has a first antenna part 10c corresponding to the first portion 1c and a second antenna part 10d corresponding to the second portion 1d. That is, the booster antenna 10D has the first antenna part 10c disposed to overlap the coil substrate 30, and the second antenna part 10d formed to be folded back (bent) from the first antenna part 10c, and disposed along the inner surface of the housing 5C.

Also, similarly to the third embodiment, the first magnetic material sheet 20D according to the fourth embodiment has a first magnetic material part 20c corresponding to the first portion 1c and a second magnetic material part 20d corresponding to the second portion 1d. That is, the first magnetic material sheet 20D has the first magnetic material part 20c disposed to overlap the coil substrate 30, and the second magnetic material part 20d formed to be folded (bent) from the first magnetic material part 20c and disposed along the inner surface of the housing 5C.

Note that the second magnetic material part 20d of the first magnetic material sheet 20D is formed along the inner surface of the metal part 8 (tapered portion) on the upper side of the housing 5C, but is not formed along the inner surface of the upper portion of the housing 5C. That is, the size of the first magnetic material sheet 20D is smaller than that of the booster antenna 10D, and the first magnetic material sheet 20D exists only the middle of the second portion 1d of the booster antenna structure 1D.

Here, in the booster antenna structure 1D, attention is paid to the first portion 1c disposed to overlap the coil substrate 30. In the first portion 1c, the first magnetic material part 20c of the first magnetic material sheet 20D is disposed on the coil substrate 30, and the first antenna part 10c of the booster antenna 10D is disposed on the first magnetic material part 20c. That is, the first magnetic material part 20c is disposed on the inner side of the housing 5C relative to the first antenna part 10c, and vice versa, the first antenna part 10c is disposed on the outer side of the housing 5C relative to the first magnetic material part 20c. Also, the first magnetic material part 20c is interposed between the first antenna part 10c and the coil substrate 30.

Next, in the booster antenna structure 1D, attention is paid to the second portion 1d formed to be folded back from the first portion 1c. First, once attention is paid to a portion along the inner surface of the metal part 8 (tapered portion) in the second portion 1d, in this portion, a second magnetic material part 20d of the first magnetic material sheet 20D is disposed on the second antenna part 10d of the booster antenna 10D.

That is, the second antenna part 10d is disposed on the inner side of the housing 5C relative to the second magnetic material part 20d, and vice versa, the second magnetic material part 20d is disposed on the outer side of the housing 5A relative to the second antenna part 10d. Also, the second magnetic material part 20d is interposed between the second antenna part 10d and the metal part 8 (tapered portion) of the housing 5C, and the second magnetic material part 20d magnetically shields the second antenna part 10d from the metal part 8.

Next, once attention is paid to a portion along the inner surface of the upper portion of the housing 5C in the second portion 1d, in this portion, the second antenna part 10d of the booster antenna 10D exists, but the first magnetic material sheet 20D is not exist. That is, in this portion, the second magnetic material part 20d is not interposed between the second antenna part 10d and the housing 5C (nonmetal), and the second antenna part 10D is disposed at a position directly below the housing 5C.

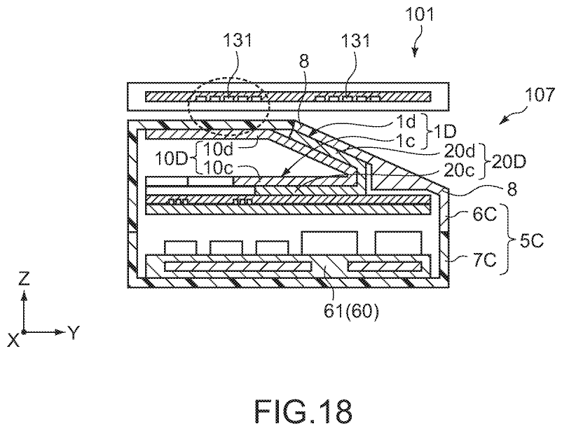

FIG. 18 is a schematic side sectional view illustrating a situation when a communication apparatus 107 according to the fourth embodiment and the reader/writer 101 communicate with each other. In the fourth embodiment, particularly, in the second portion 1d of the booster antenna structure 1D, the second magnetic material part 20d of the first magnetic material sheet 20D is interposed between the metal part (tapered portion) of the housing 5C and the second antenna part 10d of the booster antenna 10D.

Therefore, when the communication apparatus 100 receives the information from the reader/writer 101, it may be prevented that the magnetic field generated from the antenna coil 131 of the reader/writer 101 is adversely affected by the metal part 8 of the housing 5C, and the adversely-affected magnetic field interlinks with the booster antenna 10D.

Also, when the communication apparatus 100 transmits information to the reader/writer 101, it may be prevented that the magnetic field generated from the booster antenna 10D is adversely affected by the metal part 8 of the housing 5C, and the adversely-affected magnetic field interlinks with the antenna coil 131 of the reader/writer 101.

Note that the first magnetic material part 20c of first magnetic material sheet 20D may be skipped as necessary.

In the example illustrated in FIGS. 17 and 18, a case where, in the booster antenna structure 1D, a portion along the inner surface of the upper portion (nonmetal) of the housing 5A is configured with only the booster antenna 10D has been described. On the other hand, the first magnetic material sheet 20D may be provided below the booster antenna 10A in a portion along the inner surface of the upper portion (nonmetal) of the housing 5A.

In this case, the second magnetic material part 20d of the first magnetic material sheet 20D is disposed on the outer side of the housing 5C relative to the booster antenna 10D, in a portion corresponding to the metal part 8 of the housing 5C. On the other hand, the second magnetic material part 20d is disposed on the inner side of the housing 5C relative to the booster antenna 10D, in a portion corresponding to a nonmetal part of the housing 5C.

By disposing the second magnetic material part 20d at such a position, it is possible to appropriately secure communication performance with the reader/writer 101 while eliminating the adverse effect of the metal part 8 of the housing 5C in communication between the communication apparatus 107 and the reader/writer 101.

### Fifth Embodiment

Next, a fifth embodiment of the present technology will be described. The fifth embodiment is mainly different from the aforementioned respective embodiments in that a booster antenna structure 1E is not disposed inside the housing 5D of the communication apparatus 108, but is disposed inside a case 200 for accommodating the communication apparatus 108.

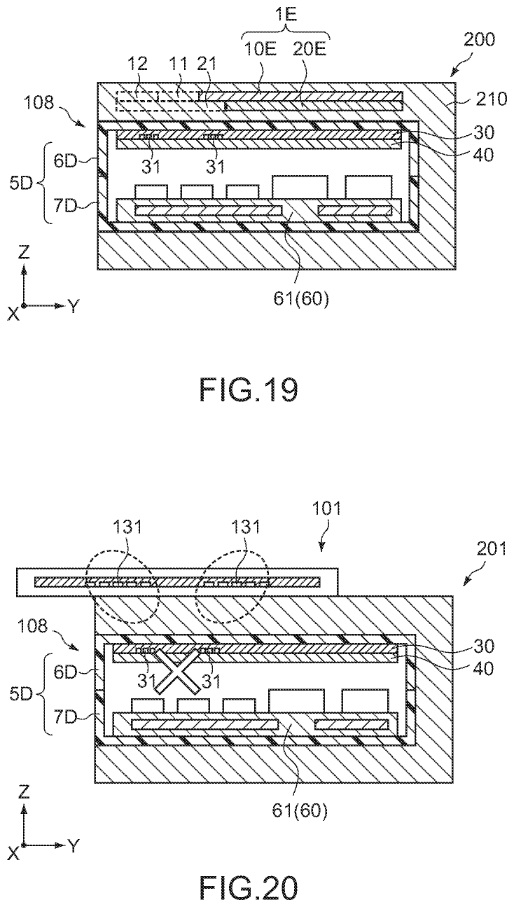

FIG. 19 is a schematic side sectional view illustrating the communication apparatus 108 and the case 200 according to the fifth embodiment. As illustrated in FIG. 19, the communication apparatus 100 has a housing 5D including an upper housing 6D and a lower housing 7D. The coil substrate 30 having an antenna coil 31, and the second magnetic material sheet 40 are disposed inside the housing 5D. The coil substrate 30 is disposed along the upper inner surface of the housing 5A, and the second magnetic material sheet 40 is disposed below the coil substrate 30.

The case 200 is, for example, a case of a smartphone when the communication apparatus 108 is the smartphone, and is a case of a camera when the communication apparatus 108 is the camera. Note that the case 200 may be any case as long as it is able to accommodate the communication apparatus 108.

The case 200 has a case main body 210 and the booster antenna structure 1E disposed inside the case main body 210. The case main body 210 is able to accommodate the housing 5D of the communication apparatus 108, and is configured to cover the periphery of the housing 5D.

Note that, when the housing 5D of the communication apparatus 100 is accommodated in the case main body 210, the case main body 210 is configured to cover at least a position (a position where communication is performed) in the housing 5D, where the coil substrate 30 and the second magnetic material sheet 40 are disposed.

The booster antenna structure 1E is disposed inside the case main body 210. Note that the booster antenna structure 1E may be provided outside the case main body 210. For example, the booster antenna structure 1E may be attached to the outer peripheral surface or the inner peripheral surface of the case main body 210.

The booster antenna structure 1E is disposed at a position corresponding to the coil substrate 30 and the second magnetic material sheet 40, in the inside of the case main body 210. Specifically, the booster antenna structure 1E is disposed in a portion (an upper portion of the case main body 210 in the example illustrated in FIG. 20), out of each portion of the case main body 210, which covers a position where the coil substrate 30 and the second magnetic material sheet 40 are disposed.

The booster antenna structure 1E has a laminated structure including a booster antenna 10E and a first magnetic material sheet 20E. The booster antenna 10E is disposed on an outer side relative to the first magnetic material sheet 20E (on a reader/writer 101 side: communication party side) in the inside of the case main body 210.

The booster antenna 10E is configured to be magnetically coupled to the antenna coil 31 disposed inside the housing 5D of the communication apparatus 100, in a state where the housing 5D of the communication apparatus 100 is accommodated in the case main body 210. Note that in the example illustrated in FIG. 19, the size of the booster antenna 10E is a size substantially equal to the size of coil substrate 30, but the size of booster antenna 10E may be configured to be larger than the size of coil substrate 30.

The first magnetic material sheet 20E is disposed on an inner side relative to the booster antenna 10E (on the communication apparatus 108 side) in the inside of the case main body 210. In the example illustrated in FIG. 19, the size of the first magnetic material sheet 20E is a size substantially equal to the size of the coil substrate 30, but the size of the first magnetic material sheet 20E may be configured to be larger than the size of the coil substrate 30.

The positions, sizes, and shapes of the opening 11 and the slit part 12 of the booster antenna 10E, and the position, size, and shape of the notch 21 of the first magnetic material sheet 20E are the same as those of the aforementioned first embodiment.

FIG. 20 is a schematic side sectional view illustrating a state where the communication apparatus 108 is accommodated in a case 201 according to the comparative example. The case 201 according to the comparative example is different from a case 200 according to the fifth embodiment in that the case 201 does not have the booster antenna structure 1E.

In the case 201 according to the comparative example, the magnetic field generated by the antenna coil 131 of the reader/writer 101 or the magnetic field generated by the antenna coil 31 of the communication apparatus 100 is disturbed by the case 200 and does not reach the antenna coils 31 and 131 of the other party. Therefore, the communication apparatus 108 and the reader/writer 101 are not able to communicate with each other. Therefore, a user needs to remove the communication apparatus 108 from the case 201 when performing communication between the communication apparatus 108 and the reader/writer 101.

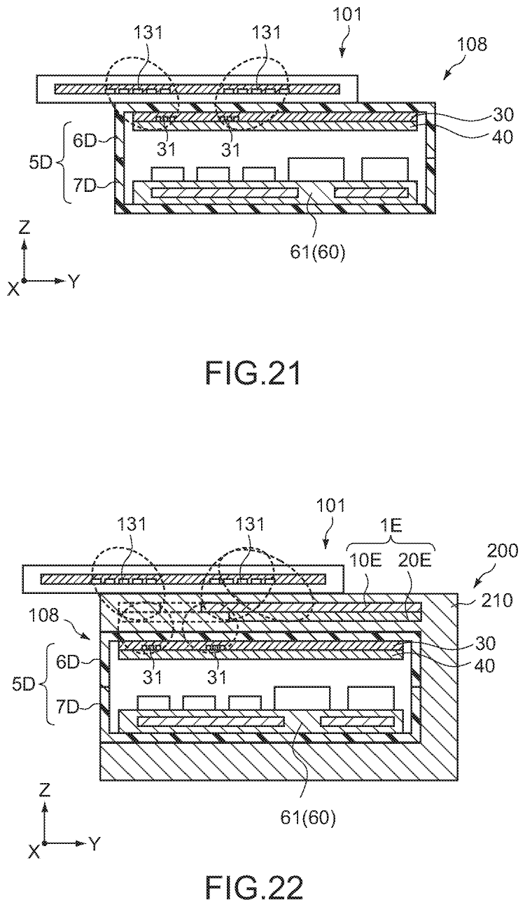

FIG. 21 is a schematic sectional view illustrating a situation when the communication apparatus 108 and the reader/writer 101 communicate with each other in a state where the communication apparatus 108 is removed from the case 201. As illustrated in FIG. 21, the communication apparatus 108 and the reader/writer 101 are able to communicate with each other in a state where the communication apparatus 108 is removed from the case 201.

FIG. 22 is a schematic side sectional view illustrating a situation when the communication apparatus 100 and the reader/writer 101 communicate with each other in a state where the communication apparatus 108 is accommodated in the case 200 according to the fifth embodiment.

As described above, in the fifth embodiment, the booster antenna structure 1E having a laminated structure including the booster antenna 10E and the first magnetic material sheet 20E is disposed in the case main body 210. Therefore, as illustrated in FIG. 22, the magnetic field generated by the antenna coil 131 of the reader/writer 101 is coupled to the booster antenna 10E, and further, the magnetic field generated by the booster antenna 10E is coupled to the antenna coil 31 of the communication apparatus 108. Also, a magnetic field generated by the antenna coil 31 of the communication apparatus 108 is coupled to the booster antenna 10E, and further, a magnetic field generated by the booster antenna 10E is coupled to the antenna coil 131 of the reader/writer 101.

As described above, in the fifth embodiment, even in a state where the communication apparatus 108 is accommodated in the case 200, the communication apparatus 108 and the reader/writer 101 are able to communicate with each other. In this way, the user is able to communicate with the communication apparatus 108 and the reader/writer 101 while the communication apparatus 108 is accommodated in the case 200. Therefore, the user is freed from the inconvenience of having to remove the case 200 from the communication apparatus 108 each time communication is performed.

Note that, for example, the antenna structure 1E may be provided across two or more portions of the case main body 210 (similarly applicable to embodiments to be described later). The basic idea about this is the same as that of the aforementioned second embodiment (see FIG. 13). For example, the booster antenna structure 1A may be provided across two surfaces of the upper and right portions in the case main body 210, or may be provided across three surfaces of the upper, right, and lower portions in the case main body 210.

In this way, when communication is performed by bringing the reader/writer 101 close to the communication apparatus 108 (accommodated in the case 200), it is possible to perform communication by bringing the reader/writer 101 close to the communication apparatus 108 from a plurality of directions. Also, in a case where communication is performed by bringing the communication apparatus 108 (accommodated in the case 200) closer to the reader/writer 101, it is possible to perform communication regardless of the posture of the communication apparatus 108.

### Sixth Embodiment

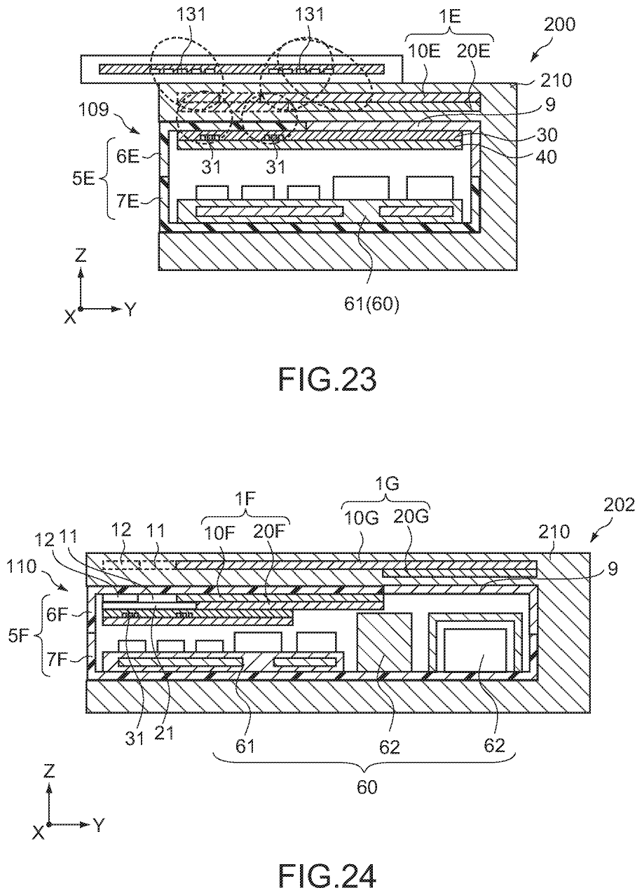

Next, a sixth embodiment of the present technology will be described. FIG. 23 is a schematic side sectional view illustrating a communication apparatus 109 and the case 200 according to the sixth embodiment. In the sixth embodiment, the configuration of the housing 5E in the communication apparatus 109 is different from that of the aforementioned fifth embodiment. Note that in the sixth embodiment, the configuration of the case 200 is the same as that of the fifth embodiment.

As illustrated in FIG. 23, the communication apparatus 109 has a housing 5E including an upper housing 6E and a lower housing 7E. The housing 5E has a metal part 9 in a part of the upper housing 6E (upper right in FIG. 23). In the housing 5E, the other portions are nonmetals such as resin.

The first magnetic material sheet 20E is interposed between the booster antenna 10E in the case 200 and the metal part 9 of the housing 5E in the communication apparatus 109, in a state where the communication apparatus 109 is accommodated in the case 200. That is, the first magnetic material sheet 20E magnetically shields the booster antenna 10E from the metal part 9 in the communication apparatus 109.

In this way, when the communication apparatus 109 receives information from the reader/writer 101, it may be prevented that the magnetic field generated from the antenna coil 131 of the reader/writer 101 is coupled to the metal part 9 of the housing 5E to be damped.

Note that the size of the first magnetic material sheet 20E may be smaller than the size of the booster antenna 10E. That is, in a case where the metal part 9 of the housing 5E is small, it is possible to reduce the size of the first magnetic material sheet 20A according to the size of the metal part 9.

### Seventh Embodiment

Next, a seventh embodiment according to the present technology will be described. FIG. 24 is a schematic side sectional view illustrating a communication apparatus 110 and a case 202 according to the seventh embodiment.

As illustrated in FIG. 24, in the seventh embodiment, the booster antenna structure 1F is provided in the communication apparatus 110, and the booster antenna structure 1G is also provided in the case 202.

The communication apparatus 110 has a housing 5F including an upper housing 6F and a lower housing 7F. The housing 5F has a metal part 9 in a part of the upper housing 6F (upper right in FIG. 24). In the housing 5F, the other portions are nonmetals such as resin.

The booster antenna structure 1F of the communication apparatus 110 is disposed at a position for avoiding the metal part 9 in the housing 5F on the upper side inside the housing 5F. That is, the booster antenna structure 1F is disposed at a position corresponding to a portion configured with nonmetal such as resin in the housing 5A.

A booster antenna 10F of the communication apparatus 110 is configured to be magnetically coupled to the antenna coil 31 of the communication apparatus 110. Also, the booster antenna 10F of the communication apparatus 110 is configured to be magnetically coupled to a booster antenna 10G in the case 202, in a state where the communication apparatus 110 is accommodated in the case 202. The first magnetic material sheet 20F in the communication apparatus 110 magnetically shields the booster antenna 10F in the communication apparatus 110 from the metal components 60 of the communication apparatus 110.

The size of the booster antenna structure 1G in the case 202 is larger than the size of the booster antenna structure 1F in the communication apparatus 110. In the example illustrated in the figure, the width of the booster antenna structure 1G in the case 202 is the same as the width of the booster antenna structure 1F in the communication apparatus 110, but the length of the booster antenna structure 1G in the case 202 is greater than the length of the booster antenna structure 1F in the communication apparatus 110.

The booster antenna 10G of the case 202 is configured to be magnetically coupled to the antenna coil 31 in the communication apparatus 110 through the booster antenna 10F in the communication apparatus 110, in a state where the communication apparatus 110 is accommodated in the case 202.

Also, the first magnetic material sheet 20G of the case 202 is interposed between the booster antenna 10G of the case 202 and the metal part 9 of the communication apparatus 110 in a state where the communication apparatus 110 is accommodated in the case 202. In this way, the first magnetic material sheet 20G of the case 202 magnetically shields the booster antenna 10G of the case 202 from the metal part 9 of the housing 5F.

The size of the first magnetic material sheet 20G of the case 202 is smaller than the size of the booster antenna 10G of the case 202. Also, the first magnetic material sheet 20G is not interposed between the booster antenna 10G of the case 202 and the booster antenna 10F of the communication apparatus 100 in a state where the communication apparatus 110 is accommodated in the case 202. This is because, when the first magnetic material sheet 20G is interposed between the two booster antennas 10G and 10F, the first magnetic material sheet 20G interferes with the magnetic field coupling of the two booster antennas 10G and 10F.

In the sixth embodiment, booster antenna structures 1F and 1G are provided in both the communication apparatus 110 and the case 202. Therefore, even in a state where the communication apparatus 110 is removed from the case 202, and even in a state where the communication apparatus 110 is accommodated in the case 202, it is possible to appropriately secure communication performance.

Also, in the sixth embodiment, the first magnetic material sheet 20G of the case 200 is interposed between the booster antenna 10G of the case 200 and the metal part 9 of the communication apparatus 100, but is not interposed between two booster antennas 10G and 10F. Therefore, it is possible to appropriately perform magnetic coupling between two booster antennas 10G and 10F while appropriately eliminating the adverse effect of the metal part 9 of the housing 5F.

### VARIOUS MODIFIED EXAMPLES

In the above description, although a case where antenna structures 1A to 1G are used as an antenna in a short-range wireless communication method such as NFC has been described, antenna structures 1A to 1G may be used as an antenna for wireless communication such as Bluetooth, ZigBee, or Wi-Fi.

The present technology may also have the following configurations.
(1) A booster antenna structure, including:
a booster antenna magnetically coupled to an antenna coil of a coil substrate disposed inside a housing of a communication apparatus; and a first magnetic material sheet, the booster antenna structure being disposed at a position on an outer side relative to the coil substrate in the inside of the housing, and having a size larger than a size of the coil substrate.
(2) The booster antenna structure according to (1), in which
the booster antenna structure is a laminated structure including the booster antenna and the first magnetic material sheet.
(3) The booster antenna structure according to (1) or (2), in which
the first magnetic material sheet is disposed between the booster antenna and the coil substrate.
(4) The booster antenna structure according to (3), in which
a metal component is disposed inside the housing, and the first magnetic material sheet is disposed between the metal component and a portion where the booster antenna exceeds the coil substrate.
(5) The booster antenna structure according to any one of (1) to (4), in which
the first magnetic material sheet has a notch at a position corresponding to the antenna coil.
(6) The booster antenna structure according to (5), in which
a size of the notch is equal to or larger than a size of the antenna coil.
(7) The booster antenna structure according to any one of (1) to (6), in which
the booster antenna and the first magnetic material sheet are integrated to configure the booster antenna structure.
(8) The booster antenna structure according to (7), in which
when the booster antenna structure is disposed inside the housing, the booster antenna structure is individually disposed separately from the coil substrate.
(9) The booster antenna structure according to any one of (1) to (8), in which
the housing has two or more inner surfaces, and the booster antenna structure is provided across the two or more inner surfaces.
(10) The booster antenna structure according to (1), in which
the housing has an inner surface, and
the booster antenna structure has a first portion disposed to overlap the coil substrate, and a second portion formed to be bent from the first portion and disposed along the inner surface of the housing.
(11) The booster antenna structure according to (10), in which
the booster antenna has a first antenna part corresponding to the first portion, and a second antenna part corresponding to the second portion, and
the first magnetic material sheet has a magnetic material part disposed at a position on an inner side of the housing relative to the second antenna part.
(12) The booster antenna structure according to (10), in which
the housing has a metal part in a part of a place along the second portion,
the booster antenna has a first antenna part corresponding to the first portion, and a second antenna part corresponding to the second portion, and
the first magnetic material sheet has a magnetic material part disposed between the second antenna part and the metal part of the housing.
(13) The booster antenna structure according to any one of (1) to (12), in which
a metal component is disposed inside the housing, and a second magnetic material sheet is disposed between the coil substrate and the metal component.
(14) The booster antenna structure according to any one of (1) to (13), in which
another booster antenna structure including another booster antenna and another first magnetic material sheet is provided in a case for accommodating the housing of the communication apparatus, and
the booster antenna is magnetically coupled to the other booster antenna in a state where the communication apparatus is accommodated in the case.
(15) The booster antenna structure according to (14), in which
the housing has a metal part in a part, and
the other first magnetic material sheet is disposed between the other booster antenna and the metal part in a state where the communication apparatus is accommodated in the case.
(16) A booster antenna structure, including:
a booster antenna magnetically coupled to an antenna coil in a state where a communication apparatus having a housing in which the antenna coil is disposed is accommodated in a case for accommodating the housing; and a first magnetic material sheet, the booster antenna structure being disposed in the case.
(17) The booster antenna structure according to (16), in which
the housing has a metal part in a part, and
the first magnetic material sheet is disposed between the booster antenna and the metal part in a state where the communication apparatus is accommodated in the case.
(18) A communication apparatus, including:
a housing; and
a booster antenna structure including a booster antenna magnetically coupled to an antenna coil of a coil substrate disposed inside the housing, and a first magnetic material sheet, the booster antenna structure being disposed at a position on an outer side relative to the coil substrate in the inside of the housing, and having a size larger than a size of the coil substrate.
(19) A case, including:
a case main body that accommodates a housing of a communication apparatus having the housing in which an antenna coil is disposed; and
a booster antenna structure including a booster antenna magnetically coupled to the antenna coil in a state where the communication apparatus is accommodated in the case main body, and a first magnetic material sheet, the booster antenna structure being disposed in the case main body.

### REFERENCE SIGNS LIST

1A to 1G booster antenna structure
5A to 5F housing
10A to 10G booster antenna
20A to 20G first magnetic material sheet
30 coil substrate
31 antenna coil
40 second magnetic material sheet
50 antenna device
60 metal components
100, 103 to 110 communication apparatus
101 reader/writer
200 to 202 case

1. A booster antenna structure, comprising:
a booster antenna magnetically coupled to an antenna coil of a coil substrate disposed inside a housing of a communication apparatus; and a first magnetic material sheet, the booster antenna structure being disposed at a position on an outer side relative to the coil substrate in the inside of the housing, and having a size larger than a size of the coil substrate.

2. The booster antenna structure according to claim 1, wherein
the booster antenna structure is a laminated structure including the booster antenna and the first magnetic material sheet.

3. The booster antenna structure according to claim 1, wherein
the first magnetic material sheet is disposed between the booster antenna and the coil substrate.

4. The booster antenna structure according to claim 3, wherein
a metal component is disposed inside the housing, and
the first magnetic material sheet is disposed between the metal component and a portion where the booster antenna exceeds the coil substrate.

5. The booster antenna structure according to claim 1, wherein
the first magnetic material sheet has a notch at a position corresponding to the antenna coil.

6. The booster antenna structure according to claim 5, wherein
a size of the notch is equal to or larger than a size of the antenna coil.

7. The booster antenna structure according to claim 1, wherein
the booster antenna and the first magnetic material sheet are integrated to configure the booster antenna structure.

8. The booster antenna structure according to claim 7, wherein
when the booster antenna structure is disposed inside the housing, the booster antenna structure is individually disposed separately from the coil substrate.

9. The booster antenna structure according to claim 1, wherein
the housing has two or more inner surfaces, and
the booster antenna structure is provided across the two or more inner surfaces.

10. The booster antenna structure according to claim 1, wherein
the housing has an inner surface, and
the booster antenna structure has a first portion disposed to overlap the coil substrate, and a second portion formed to be bent from the first portion and disposed along the inner surface of the housing.

11. The booster antenna structure according to claim 10, wherein
the booster antenna has a first antenna part corresponding to the first portion, and a second antenna part corresponding to the second portion, and
the first magnetic material sheet has a magnetic material part disposed at a position on an inner side of the housing relative to the second antenna part.

12. The booster antenna structure according to claim 10, wherein
the housing has a metal part in a part of a place along the second portion,
the booster antenna has a first antenna part corresponding to the first portion, and a second antenna part corresponding to the second portion, and
the first magnetic material sheet has a magnetic material part disposed between the second antenna part and the metal part of the housing.

13. The booster antenna structure according to claim 1, wherein
a metal component is disposed inside the housing, and
a second magnetic material sheet is disposed between the coil substrate and the metal component.

14. The booster antenna structure according to claim 1, wherein
another booster antenna structure including another booster antenna and another first magnetic material sheet is provided in a case for accommodating the housing of the communication apparatus, and
the booster antenna is magnetically coupled to the other booster antenna in a state where the communication apparatus is accommodated in the case.

15. The booster antenna structure according to claim 14, wherein
the housing has a metal part in a part, and
the other first magnetic material sheet is disposed between the other booster antenna and the metal part in a state where the communication apparatus is accommodated in the case.

16. A booster antenna structure, comprising:
a booster antenna magnetically coupled to an antenna coil in a state where a communication apparatus having a housing in which the antenna coil is disposed is accommodated in a case for accommodating the housing; and a first magnetic material sheet, the booster antenna structure being disposed in the case.

17. The booster antenna structure according to claim 16, wherein
the housing has a metal part in a part, and
the first magnetic material sheet is disposed between the booster antenna and the metal part in a state where the communication apparatus is accommodated in the case.

18. A communication apparatus, comprising:
a housing; and
a booster antenna structure including a booster antenna magnetically coupled to an antenna coil of a coil substrate disposed inside the housing, and a first magnetic material sheet, the booster antenna structure being disposed at a position on an outer side relative to the coil substrate in the inside of the housing, and having a size larger than a size of the coil substrate.

19. A case, comprising:
a case main body that accommodates a housing of a communication apparatus having the housing in which an antenna coil is disposed; and
a booster antenna structure including a booster antenna magnetically coupled to the antenna coil in a state where the communication apparatus is accommodated in the case main body, and a first magnetic material sheet, the booster antenna structure being disposed in the case main body.
